(19) United States
(12) Patent Application Publication
(10) Pub. No.: US 2026/0103150 A1
(43) Pub. Date: Apr. 16, 2026

(54) MOUNT STRUCTURE IN VEHICULAR INTERIOR COMPONENT

(71) Applicants: TOYOTA BOSHOKU KABUSHIKI KAISHA, Aichi-ken (JP); TOYOTA JIDOSHA KABUSHIKI KAISHA, Aichi-ken (JP)

(72) Inventors: Mitsuhiko TAKESHIGE, Nagakute-shi (JP); Isao SHINAGAWA, Toyota-shi (JP)

(73) Assignees: TOYOTA BOSHOKU KABUSHIKI KAISHA, Aichi-ken (JP); TOYOTA JIDOSHA KABUSHIKI KAISHA, Aichi-ken (JP)

(21) Appl. No.: 19/329,734

(22) Filed: Sep. 16, 2025

(30) Foreign Application Priority Data
Oct. 15, 2024 (JP) 2024-179976

(51) Int. Cl. B60R 11/06; B60R 11/00

(52) U.S. Cl. CPC B60R 11/06; B60R 2011/0077

(57) ABSTRACT

A vehicular mount structure includes a bar member including a shaft portion and a hook portion and a vehicular interior component having a plate surface. The vehicular interior component includes a hook holding portion projecting from the plate surface and a shaft holding portion. The hook portion is fitted to the hook holding portion to be rotatable around an outer peripheral surface of the hook holding portion in a circumferential direction. The shaft portion is in the shaft holding portion to extend along the plate surface with the hook portion being fitted to the hook holding portion. The shaft holding portion receives the shaft portion of the bar member that is rotated around the hook holding portion fitted to the hook portion and is moved along the plate surface. The shaft portion is fitted in the shaft holding portion from a direction crossing an axial line of the shaft portion.

### CROSS REFERENCE TO RELATED APPLICATION

This application claims priority from Japanese Patent Application No. 2024-179976 filed on Oct. 15, 2024. The entire contents of the priority application are incorporated herein by reference.

### TECHNICAL FIELD

The present technology described herein relates to mount structure in a vehicular interior component.

### BACKGROUND

There has been known a tow hook used for towing a vehicle as a vehicle tool stored in the vehicle. The tow hook is a bar member including a bar shaft and a hook portion that is at one end of the bar shaft. The bar shaft is attached to the vehicle and a rope is hooked on the hook portion having a ring shape or a hooked shape. Such a tow hook having a bar shape is stored in a storing recess portion in a side surface of a luggage compartment. The storing recess portion includes a hooking portion on which the hook portion is hooked, an insertion portion in which another end portion of the bar shaft (an opposite side from the hook portion) is inserted, and a holding portion holding the bar shaft. The bar shaft is pushed into the storing recess portion through an opening so as to be held by the holding portion.

### SUMMARY

However, in such a structure, if a load acts on the storing recess portion due to vibration or collision during the vehicle's moving, the bar shaft may be detached from the holding portion and the tow hook may be dropped. Furthermore, if the storing recess portion is disposed adjacent to a functional component such as a battery, the functional component may be damaged by the tow hook that is dropped from the storing recess portion.

An object of the present technology described herein is to provide a mount structure in a vehicular interior component with which the bar member such as a tow hook is less likely to be detached therefrom due to vibration of collision of a vehicle.

The technology described herein is related to a vehicular mount structure that includes a bar member including a shaft portion of a bar shape and a hook portion at one end of the shaft portion, and a vehicular interior component of a plate shape having a plate surface. The vehicular interior component includes a hook holding portion configured to hold the hook portion and projecting from the plate surface of the vehicular interior component, and a shaft holding portion in which the shaft portion is arranged with extending along the plate surface of the vehicular interior component with the hook portion being fitted to the hook holding portion. The hook portion is fitted to the hook holding portion so as to be rotatable around an outer peripheral surface of the hook holding portion in a circumferential direction. The shaft portion is arranged in the shaft holding portion with extending along the plate surface of the vehicular interior component with the hook portion being fitted to the hook holding portion. The shaft holding portion receives the shaft portion of the bar member that is rotated around the hook holding portion fitted to the hook portion and is moved along the plate surface. The shaft portion is fitted in the shaft holding portion from a direction crossing an axial line of the shaft portion.

### BRIEF DESCRIPTION OF THE DRAWINGS

FIG. 1 is a rear perspective view of a luggage compartment of a vehicle that includes a mount structure of a tow hook on a cover portion according to one embodiment.

FIG. 2 is an exploded perspective view of the tow hook and a hook holding portion.

FIG. 3 is an exploded perspective view of the tow hook and the hook holding portion.

FIG. 4 is a perspective view illustrating a hook portion that is fitted to the hook holding portion.

FIG. 5 is a perspective view illustrating the tow hook that is mounted on the cover portion.

FIG. 6 is a perspective view illustrating the tow hook that is mounted on the cover portion.

FIG. 7 is an elevation view illustrating the tow hook that is mounted on the cover portion.

FIG. 8 is a cross-sectional view of the hook holding portion taken along a vehicular width direction.

FIG. 9 is a cross-sectional view illustrating the hook portion and the hook holding portion that are fitted together taken along the vehicular width direction.

FIG. 10 is a cross-sectional view illustrating the hook portion and the hook holding portion that are fitted together taken along the vehicular width direction.

FIG. 11 is a cross-sectional view of the hook holding portion taken along a front-rear direction (along line A-A in FIG. 8).

FIG. 12 is a cross-sectional view illustrating the hook portion and the hook holding portion that are fitted together taken along the front-rear direction (along line B-B in FIG. 9).

FIG. 13 is a cross-sectional view illustrating the hook portion that is mounted on the hook holding portion taken along the front-rear direction (along line C-C in FIG. 10).

FIG. 14 is a cross-sectional view illustrating a shaft portion that is held in a shaft holding portion taken along the front-rear direction (along line D-D in FIG. 7).

FIG. 15 is a cross-sectional view illustrating the shaft portion that is held in the shaft holding portion taken along the front-rear direction (along line E-E in FIG. 7).

### DETAILED DESCRIPTION

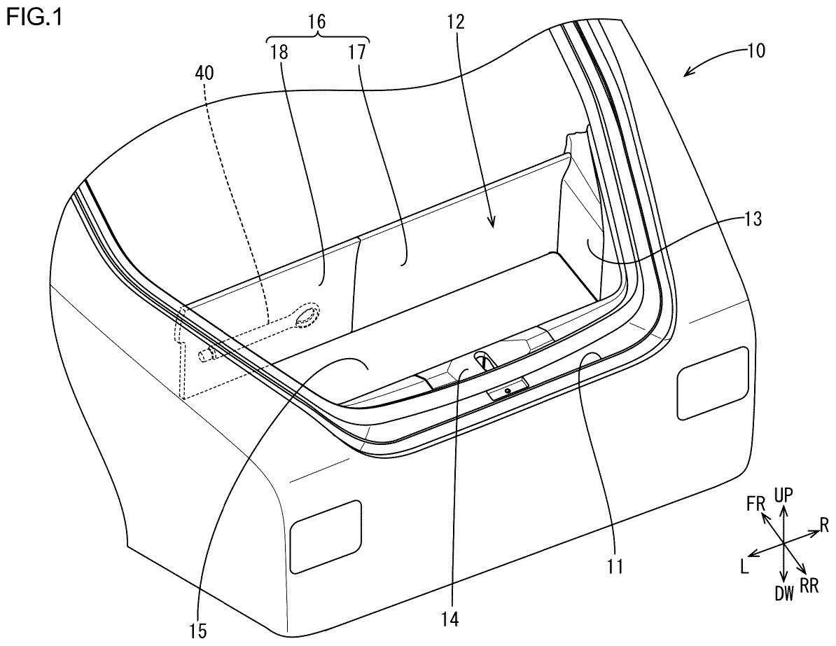

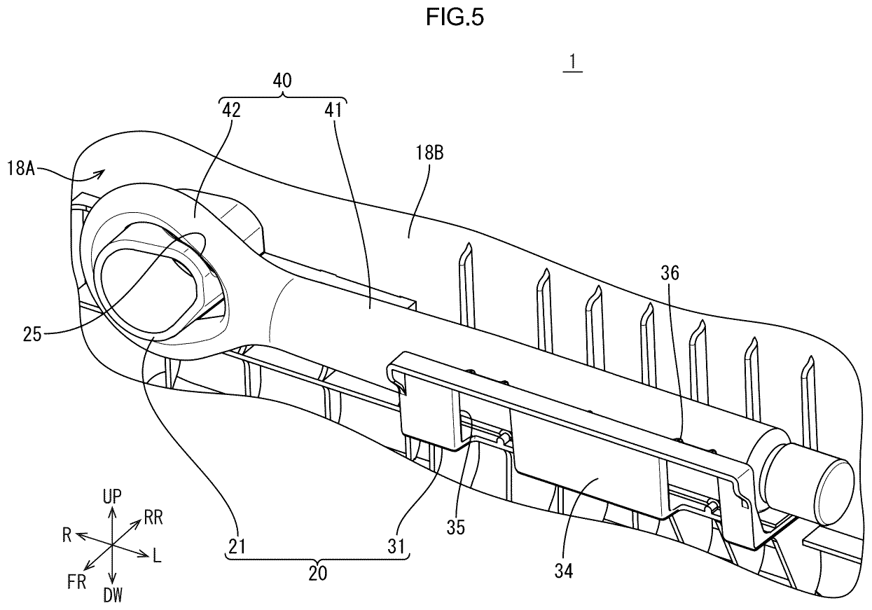

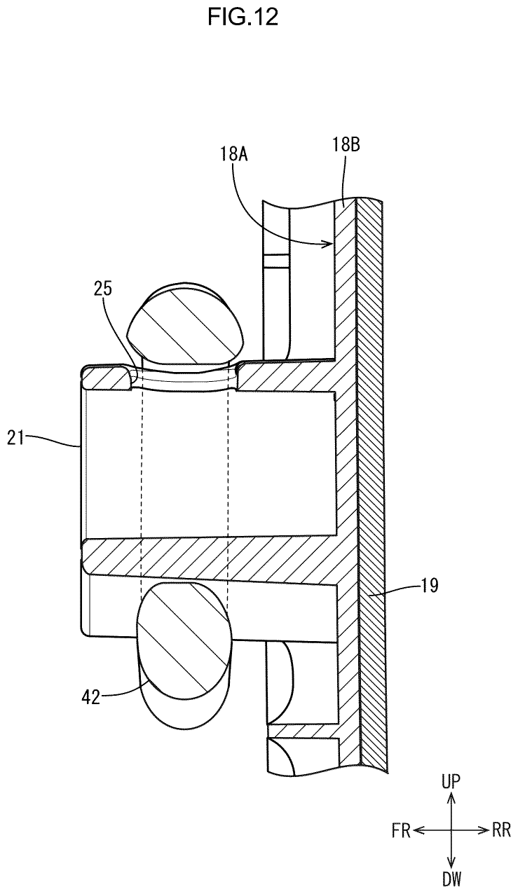

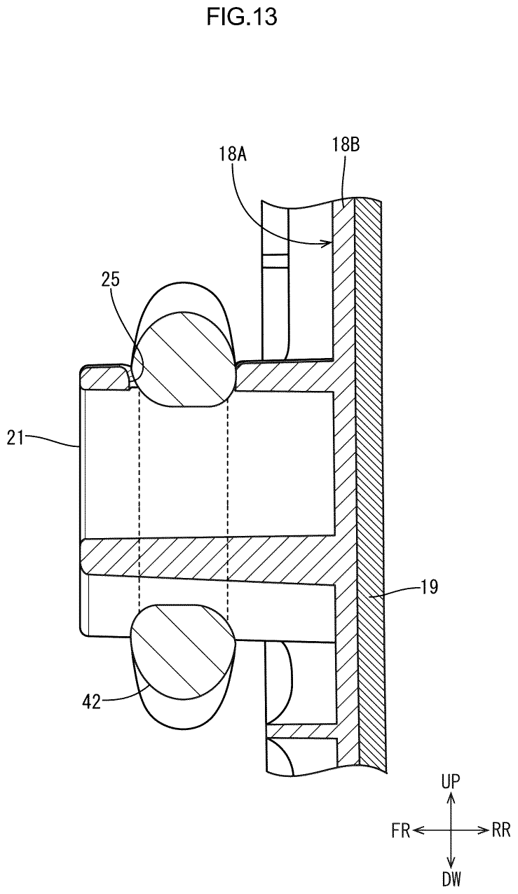

One embodiment will be described with reference to FIGS. 1 to 15. As one embodiment, a mount structure 1 of mounting a tow hook 40 on a cover portion 18 that is a portion of a front wall of a luggage compartment 12 included in a rear section of a vehicle 10 will be described. In the drawings, arrows of FR and RR represent a front side and a rear side of the vehicle 10, arrows of UP and DW represent an upper side and a lower side, and arrows of R and L represent a right side and a left side in a forwarding direction of the vehicle 10.

FIG. 1 is a perspective view of a rear section of the vehicle 10 seen from the upper left side. As illustrated in FIG. 1, the vehicle 10 of a hatchback type includes the luggage compartment 12 in the rear section and with a rear door being opened, the luggage compartment 12 is accessible through a rear opening 11.

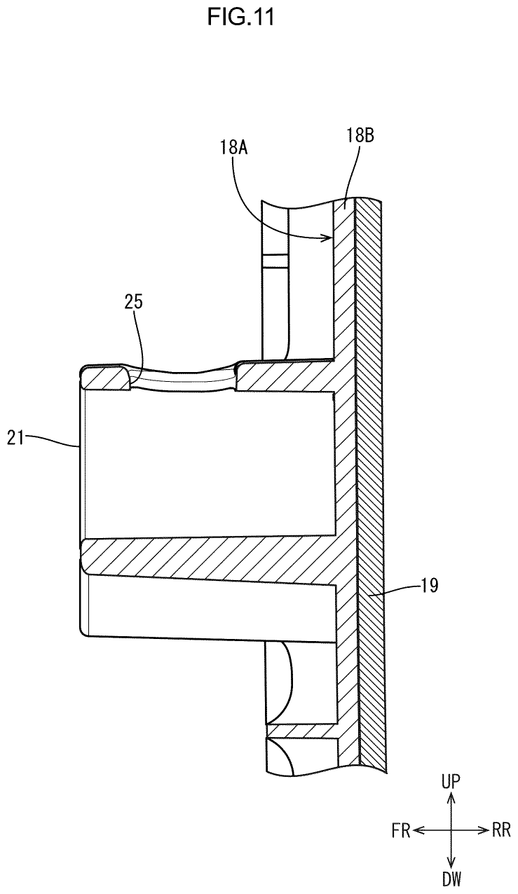

The luggage compartment 12 has a space that is defined by deck side trims 13, a finisher 14, a deck board 15, and a luggage front trim 16. The deck side trims 13 are configured as right and left side surfaces and portions of a rear surface of the luggage compartment 12. The finisher 14 is disposed between the deck side trims 13 at a rear end and configured as a middle portion of the rear surface. The deck board 15 is configured as a floor surface of the luggage compartment 12. The luggage front trim 16 is configured as a front surface. A battery (one example of a functional component) is arranged on a front left side of the luggage compartment 12. By detaching the cover portion 18, which is configured as a portion of the luggage front trim 16, the battery can be removed from the luggage compartment 12 side. As illustrated in FIG. 1, the cover portion 18 as a whole is a rectangular plate member that is configured as a left side portion of the luggage front trim 16. The cover portion 18 is detachable from a body portion 17 that is a main portion of the luggage front trim 16. An inner surface (facing the inner space of the luggage compartment 12) of the cover portion 18 is covered with a skin 19 (refer to FIG. 11).

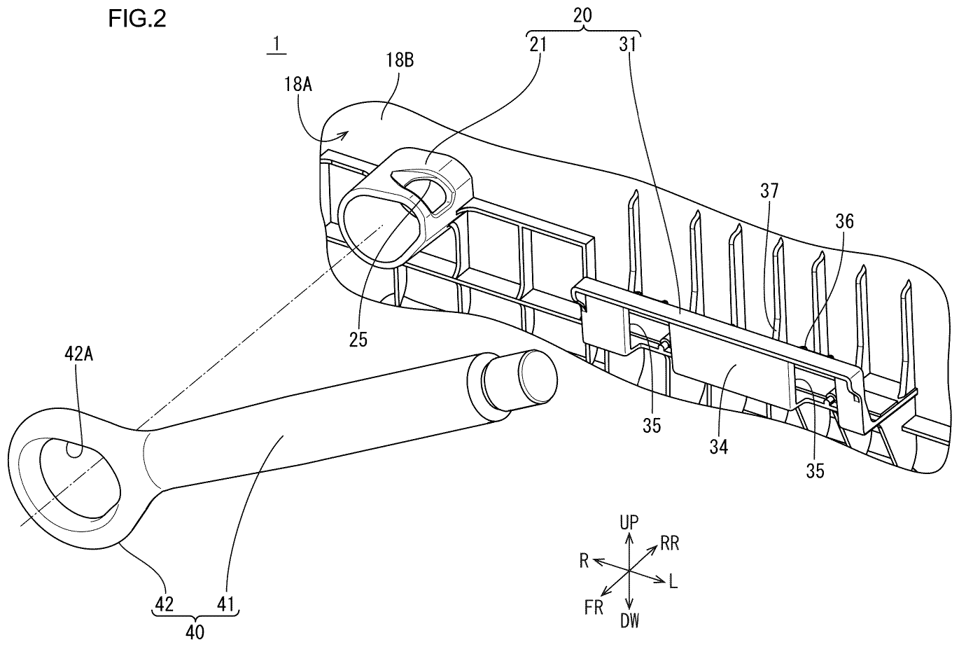

As illustrated in FIG. 2, the cover portion 18 includes a body portion 18B of a plate shape, and a tow hook holder 20 on a front surface 18A (a plate surface) of the body portion 18B that faces a vehicular front side (a surface facing an opposite side from the luggage compartment 12, a luggage compartment exterior surface). The tow hook holder 20 holds a tow hook 40 (a bar member with a hook) stored in the vehicle 10. The tow hook 40 includes a shaft portion 41 that is fixed to the vehicle 10 when used and a hook portion 42 that has a ring shape of an egg-shaped outline (an oval shape). The hook portion 42 includes a fitting hole 42A to which a hook holding portion 21 of the tow hook holder 20 is fitted. A rope for towing is hooked on the hook portion 42. The tow hook 40 corresponds to a bar member.

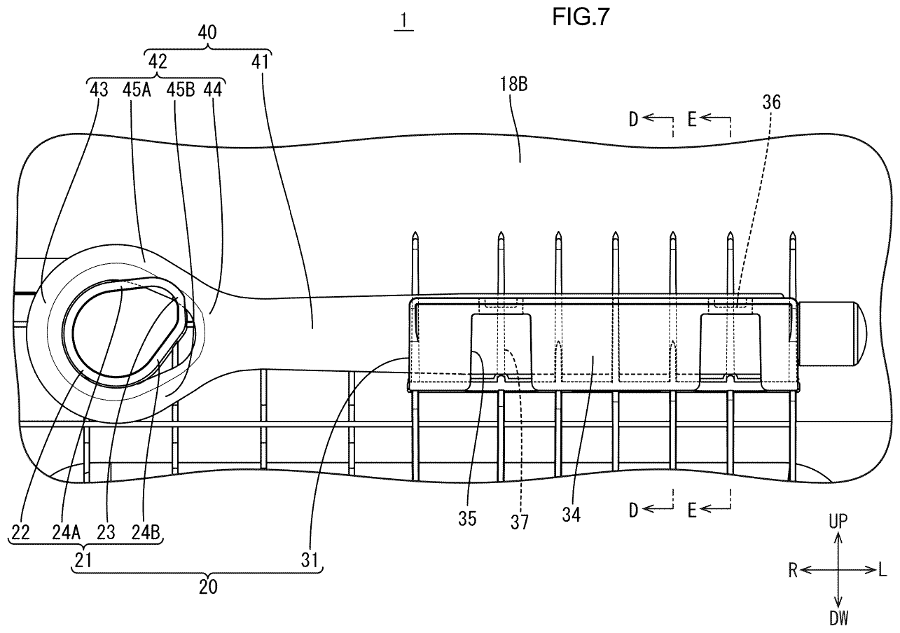

As illustrated in FIG. 7, the hook portion 42 of a ring shape having an egg-shaped outline includes a hook-side large diameter portion 43 having a large radius of curvature, a hook-side small diameter portion 44 having a small radius of curvature, and a pair of hook-side connection portions 45A, 45B. The radius of curvature of the hook-side large diameter portion 43 is larger than that of the hook-side small diameter portion 44. Each of the hook-side connection portions 45A, 45B extends straight and connects the hook-side large diameter portion 43 and the hook-side small diameter portion 44. The hook-side connection portion 45A on an upper side connects an upper one of two ends of the hook-side large diameter portion 43 and an upper one of two ends of the hook-side small diameter portion 44. The hook-side connection portion 45B connects a lower one of the two ends of the hook-side large diameter portion 43 and a lower one of the two ends of the hook-side small diameter portion 44. The shaft portion 41 extends continuously from the hook-side small diameter portion 44 of the hook portion 42.

As illustrated in FIG. 2, the tow hook holder 20 of the cover portion 18 includes a hook holding portion 21 and a shaft holding portion 31. The hook holding portion 21 projects frontward from the front surface 18A of the body portion 18B and holds the hook portion 42 of the tow hook 40. The shaft holding portion 31 is on the vehicular left side of the hook holding portion 21 and holds the shaft portion 41 of the tow hook 40.

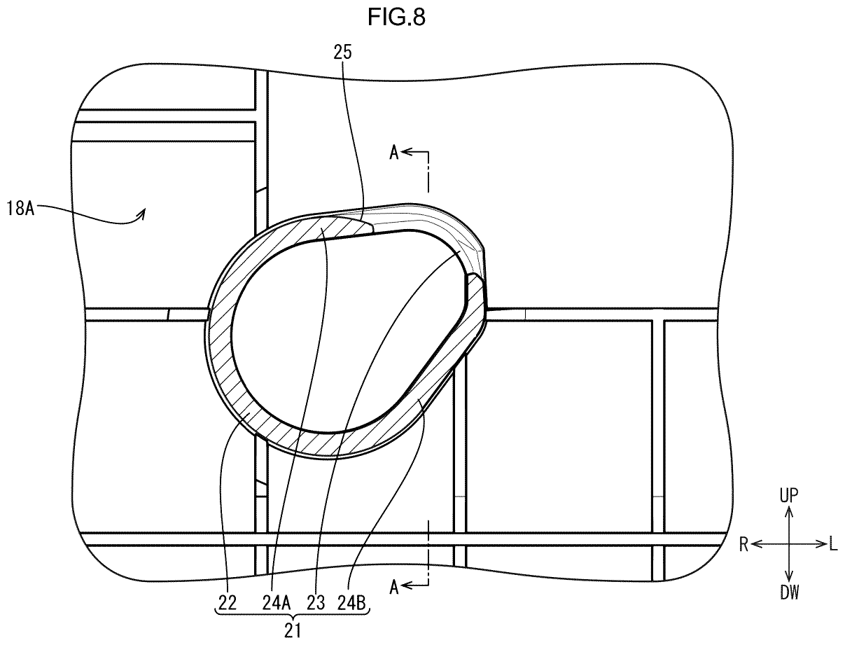

The hook holding portion 21 has a columnar shape that projects from the front surface 18A of the body portion 18B. The hook holding portion 21 has an outer shape and a dimension so as to be movably fitted in the fitting hole 42A of the hook portion 42 of the tow hook 40. Namely, the hook holding portion 21 projects frontward from the front surface 18A of the body portion 18B and has a tubular shape of an egg-shaped cross section (an oval cross section). The hook holding portion 21 projects vertically to the front surface 18A of the cover portion 18. As illustrated in FIG. 8, the hook holding portion 21 has an egg-shaped ring form similar to the ring form of the hook portion 42. The hook holding portion 21 includes a holder-side large diameter portion 22 having a large radius of curvature, a holder-side small diameter portion 23 having a small radius of curvature, and a pair of holder-side connection portions 24A, 24B. The radius of curvature of the holder-side large diameter portion 22 is larger than that of the holder-side small diameter portion 23. Each of the holder-side connection portions 24A, 24B extends straight and connects the holder-side large diameter portion 22 and the holder-side small diameter portion 23. The holder-side connection portion 24A on an upper side connects an upper one of two ends of the holder-side large diameter portion 22 and an upper one of two ends of the holder-side small diameter portion 23. The holder-side connection portion 24B on a lower side connects a lower one of the two ends of the holder-side large diameter portion 22 and a lower one of the two ends of the holder-side small diameter portion 23.

As illustrated in FIG. 8, seen along an axial direction of the tubular shape of the hook holding portion 21, the holder-side connection portion 24B extends left upper side with respect to the vehicular width direction (a right upper side in FIG. 8) at a tilt angle of about 28 degrees. The holder-side small diameter portion 23 is upper than the holder-side large diameter portion 22 seen from the vehicular front side with respect to the upper-bottom direction. A lower end of the holder-side small diameter portion 23 is upper than a lower end of the holder-side large diameter portion 22 with respect to the upper-bottom direction.

As illustrated in FIGS. 2, 3, and 8, the hook holding portion 21 includes a stopper hole 25 (an example of a hook stopper portion) that is through a tubular wall of the hook holding portion 21 in a plate thickness direction. The stopper hole 25 is in a peripheral wall of the hook holding portion 21 and extends from the holder-side connection portion 24A, which is an upper one, to the holder-side small diameter portion 23. The stopper hole 25 has an elongated shape elongated in a circumferential direction of the hook holding portion 21. The stopper hole 25 has a dimension extending in the axial direction of the hook holding portion 21 that is substantially same as a thickness of the hook portion 42. The stopper hole 25 has different diameters on the outer peripheral surface and the inner peripheral surface of the hook holding portion 21.

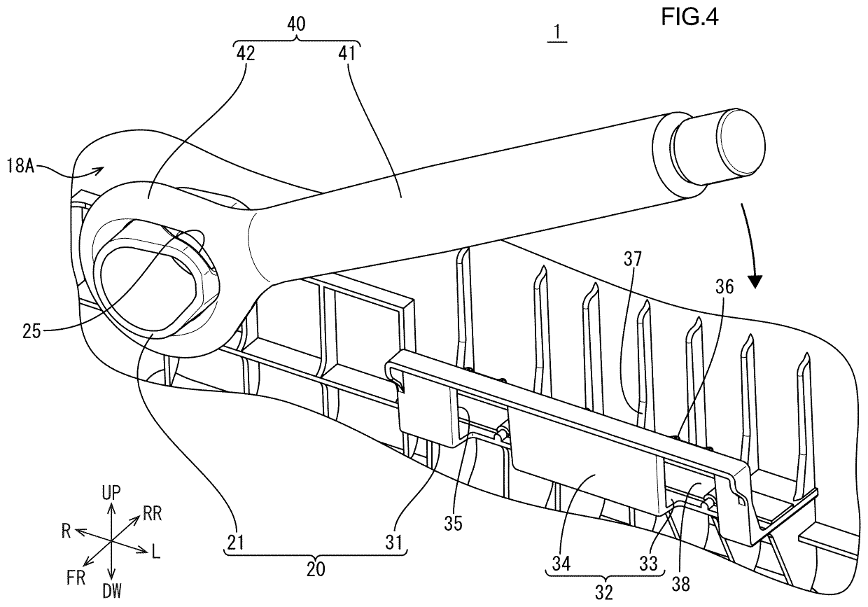

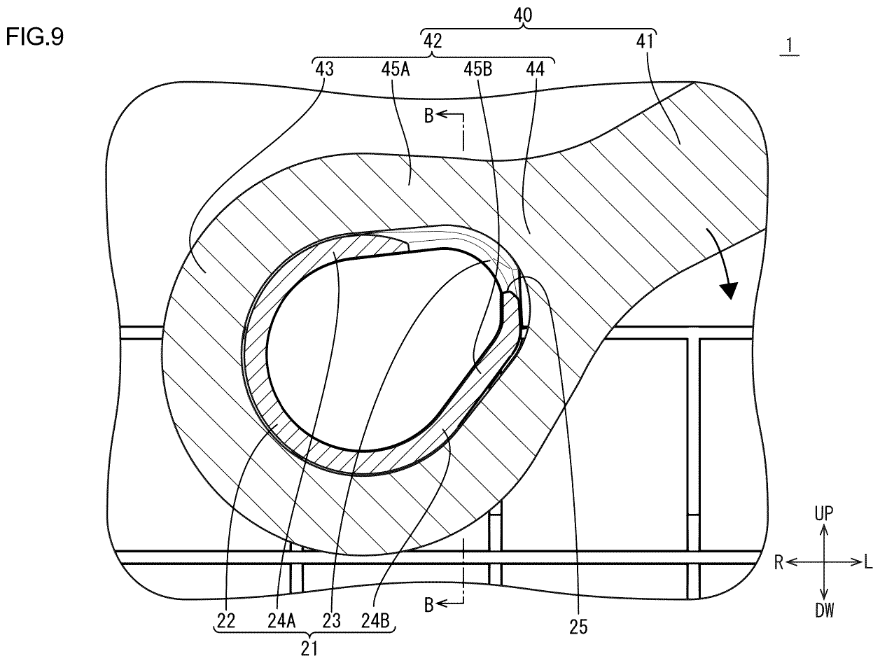

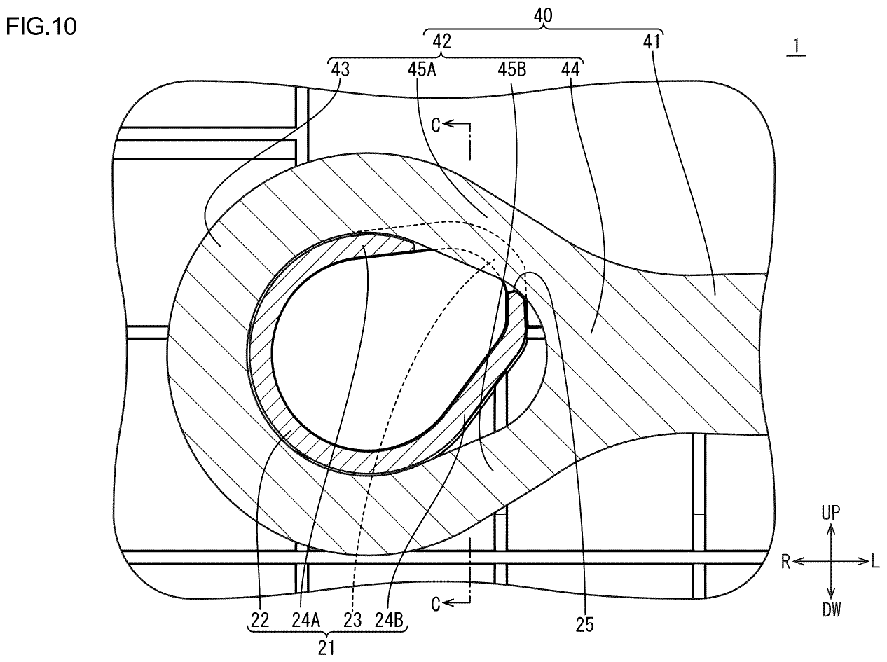

As illustrated in FIGS. 4 and 9, with the hook portion 42 of the tow hook 40 being fitted to the hook holding portion 21, the shaft portion 41 of the tow hook 40 extends obliquely upward (toward a right upper side) from the hook portion 42. Namely, the hook holding portion 21 having a tubular shape is fitted in the fitting hole 42A of the hook portion 42. Thereafter, the tow hook 40 is rotated about the hook portion 42 (the hook holding portion 21) such that an end portion of the shaft portion 41 that is an opposite end from the hook portion 42 moves downward. Then, as illustrated in FIG. 10, the hook portion 42 having a ring shape is rotated around the hook holding portion 21 and the inner peripheral portion of the hook-side connection portion 45A is fitted in the stopper hole 25. Thus, the hook portion 42 is fitted in the stopper hole 25 so as not to be separated from the hook holding portion 21 in the plate thickness direction of the cover portion 18 (refer to FIG. 7). The hook portion 42 is stably held by the hook holding portion 21.

The cover portion 18 includes the shaft holding portion 31 for holding the shaft portion 41 in a horizontal position (so as to extend in a horizontal direction) such that the hook portion 42 of the tow hook 40 is not separated from the hook holding portion 21.

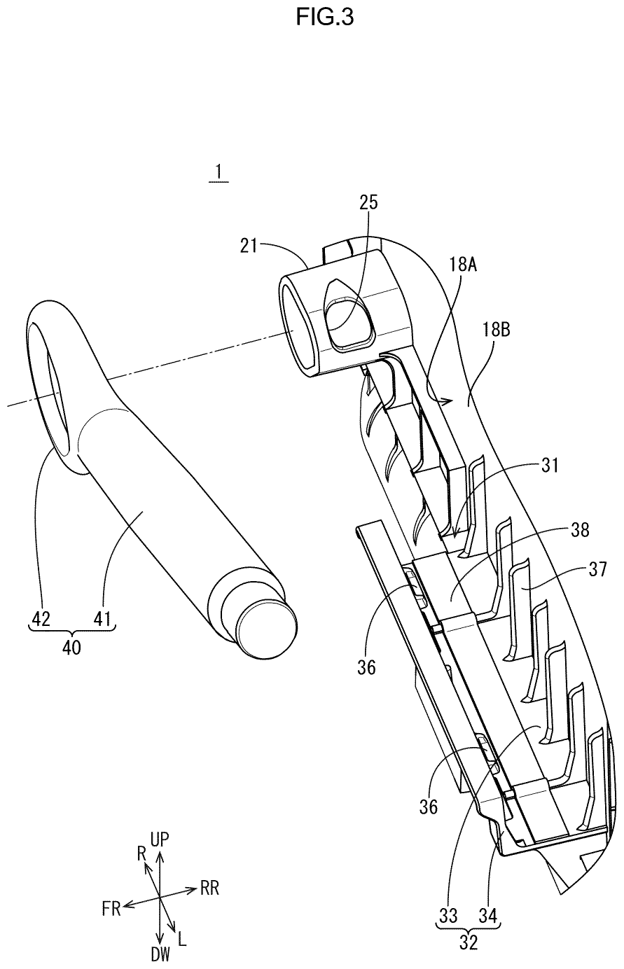

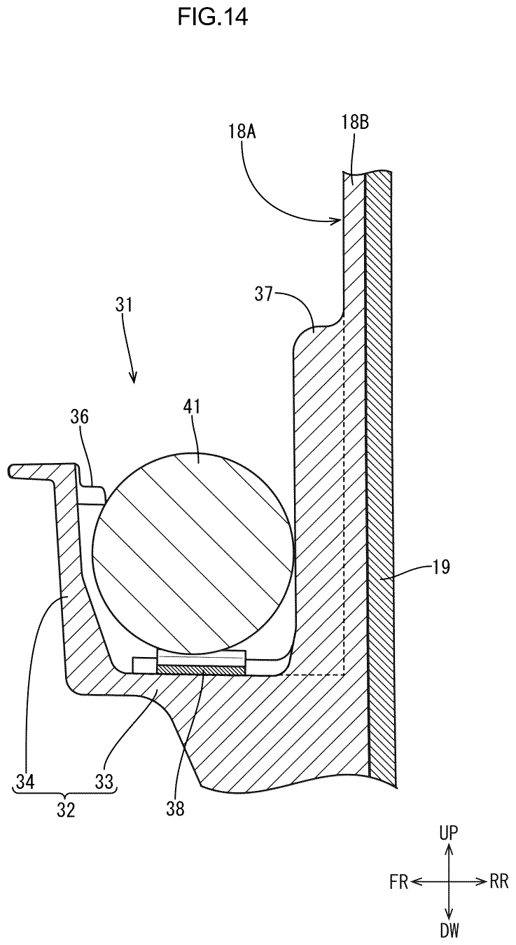

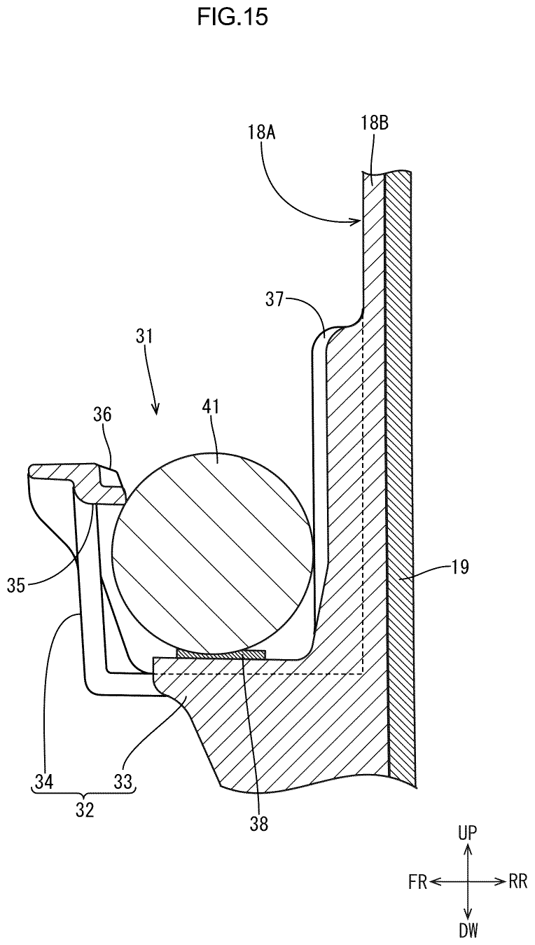

As illustrated in FIG. 3, the shaft holding portion 31 includes a projection wall 32 that projects from the front surface 18A of the base portion 18B to be formed in a L shape. The projection wall 32 is an L-shaped plate member. The shaft holding portion 31 is a groove that has a U-shaped cross section and is defined by the projection wall 32 and the body portion 18B (the front surface 18A). More specifically, as illustrated in FIGS. 14 and 15, the projection wall 32 having a L-shaped cross section includes a bottom wall 33 and a side wall 34. The bottom wall 33 projects horizontally frontward from the front surface 18A of the body portion 18. The side wall 34 extends upward from a projecting end (a front end) of the bottom wall 33. The shaft holding portion 31 is the groove of a U-shaped cross section that is surrounded by the projection wall 32 and the front surface 18A of the body portion 18B.

As illustrated in FIG. 14, a distance between the side wall 34 and the body portion 18B that is a projection dimension of the bottom wall 33 is slightly greater than the diameter of the shaft portion 41. A height of the side wall 34 is slightly greater than the diameter of the shaft portion 41. With such a configuration, almost entire portion of the shaft portion 41 with respect to the radial direction of the bar-shaped shaft portion 41 can be arranged in the shaft holding portion 31.

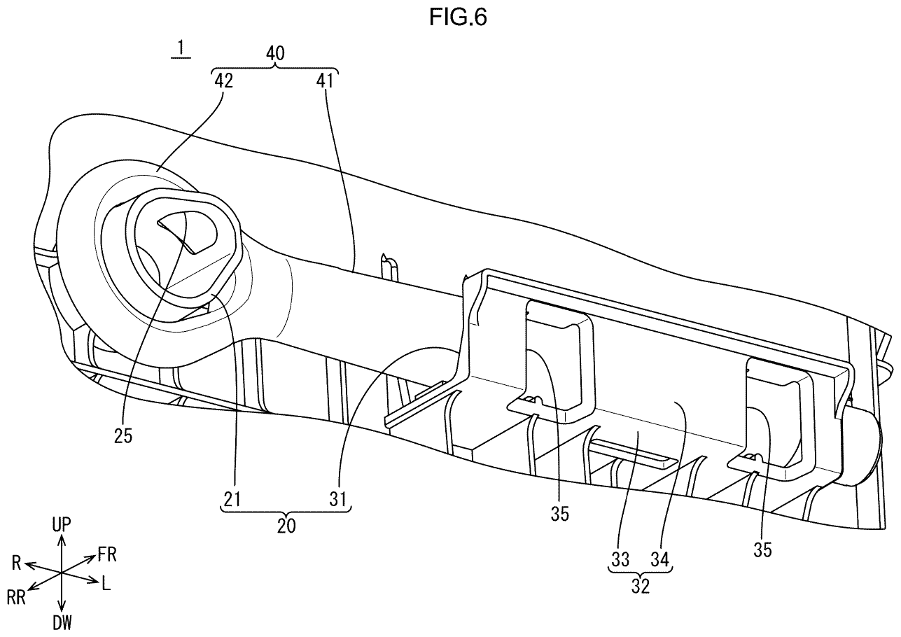

As illustrated in FIG. 6, the projection wall 32 includes two holes 35. The hole 35 is continuously in the bottom wall 33 and the side wall 34. The hole 35 extends rearward in the bottom wall 33 and continuously extends upward in the side wall 34. With the holes 35, the side wall 34 is elastically deformable such that an upper edge portion of the side wall 34 is elastically deformed frontward. A stopper projection 36 is at an upper edge of a portion of the side wall 34 having the hole 35. The stopper projection 36 is at an opening edge of an opening of the shaft holding portion 31. The stopper projection 36 projects rearward (inward of the shaft holding portion 31) from the upper edge of the side wall 34 (an opening edge of the shaft holding portion 31). As illustrated in FIG. 15, the stopper projection 36 is contacted with the shaft portion 41 of the tow hook 40, which is arranged in the shaft holding portion 31, from above. Thus, the shaft portion 41 is securely arranged in the shaft holding portion 31.

As illustrated in FIGS. 3, 4, and 7, support ribs 37 are on the front surface 18A of the body portion 18B. The support ribs 37 project from the front surface 18A toward the inner space of the shaft holding portion 31 and extends in the upper-bottom direction. As illustrated in FIGS. 14 and 15, with the support ribs 37 being contacted with the shaft portion 41 of the tow hook 40 arranged in the shaft holding portion 31, the shaft portion 41 is held fixedly in the shaft holding portion 31 and rattling is less likely to be caused in the shaft holding portion 31. The support ribs 37 extend along a direction crossing an extending direction in which the shaft portion 41 extends (an axial direction of the shaft portion 41) with the tow hook 40 being arranged in the shaft holding portion 31. Accordingly, the contact area of the tow hook 40 and the shaft holding portion 31 can be reduced to be smallest and noise caused by rattling is suppressed. The support ribs 37 reinforce the shaft holding portion 31 (the cover portion 18). With the support ribs 37, the shaft holding portion 31 can hold the tow hook 40 firmly even if a load acts on the shaft holding portion 31 (the cover portion 18) due to vibration or collision of the vehicle 10.

Furthermore, a buffer member 38 of a sheet shape is disposed on an upper surface of the bottom wall 33. With the buffer member 38, noise is less likely to be caused between the shaft portion 41 and the bottom wall 33 of the shaft holding portion 31 due to vibration of the vehicle 10.

Next, operations and effects of this embodiment will be described. The mount structure 1 of this embodiment is a structure of mounting the tow hook 40 on the front surface 18A of the cover portion 18 that covers a battery arranged in front of the luggage compartment 12 of the vehicle 10 so as to be removable from the luggage compartment 12 side. The tow hook 40 includes the bar-shaped shaft portion 41 and the ring-shaped hook portion 42 that is at one end of the shaft portion 41. The cover portion 18 includes the hook holding portion 21 holding the hook portion 42, and the shaft holding portion 31 that can hold the shaft portion 41 to extend along the front surface 18A (the plate surface) of the cover portion 18 with the hook portion 42 being held by the hook holding portion 21. The hook holding portion 21 projects from the front surface 18A of the cover portion 18 such that the hook portion 42 is fitted to the hook holding portion 21 to be movable around the hook holding portion 21 in a circumferential direction. With the tow hook 40 being rotated around the hook portion 42 that is fitted to the hook holding portion 21, the shaft portion 41 can be fitted in the shaft holding portion 31 from a direction crossing the axial line of the shaft portion 41.

According to the mount structure 1, even if a load acts on the tow hook 40 due to vibration or collision of the vehicle 10, the tow hook 40 is less likely to be detached from the cover portion 18 (the tow hook holder 20). Specifically, the hook portion 42 is fitted to the hook holding portion 21 from a direction crossing the front surface 18A (the plate surface) of the cover portion 18 (from the front side). Therefore, if a load acts on the tow hook 40 in the direction along the plate surface of the cover portion 18 (the upper-bottom direction), the hook portion 42 is less likely to be detached from the hook holding portion 21. The shaft portion 41 is fitted in the shaft holding portion 31 from the direction along the plate surface of the cover portion 18 (from above). Therefore, if a load acts on the tow hook 40 in the direction crossing the plate surface of the cover portion 18 (the front-rear direction), the shaft portion 41 is less likely to be detached from the shaft holding portion 31. Thus, the hook portion 42 of the tow hook 40 is mounted on the tow hook holder 20 in the direction crossing the front surface 18A of the cover portion 18 and the shaft portion 41 of the tow hook 40 is mounted on the tow hook holder 20 in the direction along the front surface of the cover portion 18. Accordingly, the hook portion 42 and the shaft portion 41 are mounted on the cover portion 18 (the hook holding portion 21 and the shaft holding portion 31) from different directions. Therefore, the tow hook 40 is less likely to be detached from the cover portion 18 due to vibration and collision of the vehicle 10 and the battery may not be adversely affected by the dropping of the tow hook 40.

The hook portion 42 has an egg-shaped ring shape and includes the hook-side small diameter portion 44 having a relatively small radius of curvature and the hook-side large diameter portion 43 having a relatively large radius of curvature that is larger than the radius of curvature of the hook-side small diameter portion 44. The hook holding portion 21 has an egg-shaped tubular shape that is fitted in the fitting hole 42A of the hook portion 42. The hook holding portion 21 projects from the front surface 18A of the cover portion 18. The hook holding portion 21 includes the stopper hole 25 in the peripheral wall of the hook holding portion 21. A portion of the inner peripheral portion of the hook portion 42 that is rotated around the hook holding portion 21 is fitted in the stopper hole 25. Accordingly, the hook portion 42 is held by the hook holding portion 21 so as not to be detached from the hook holding portion 21.

According to the above configuration, with the tow hook 40 being held in a correct position with respect to the cover portion 18, the hook portion 42 is held by the hook holding portion 21 so as not to be detached from the hook holding portion 21. Therefore, the tow hook 40 is less likely to be detached from the cover portion 18.

The shaft holding portion 31 has an opening that opens in the direction along the plate surface of the cover portion 18 (upward) and the shaft holding portion 31 includes the stopper projection 36 at the opening edge. The shaft portion 41 that is arranged in the shaft holding portion 31 is stopped by the stopper projection 36 so as not to be detached from the shaft holding portion 31. According to such a configuration, the shaft portion 41 is stably held in the shaft holding portion 31.

The shaft holding portion 31 is a groove that extends in a horizontal direction along the plate surface of the cover portion 18. The shaft holding portion 31 includes the support ribs 37 on an inner surface of the shaft holding portion 31. The support ribs 37 extend in the upper-bottom direction that crosses the extending direction in which the shaft holding portion 31 extends. The support ribs 37 support the shaft portion 41. According to such a configuration, the shaft portion 41 can be held in the shaft holding portion 31 without rattling. The shaft holding portion 31 is reinforced by the support ribs 37.

The shaft holding portion 31 has a groove shape that extends along the plate surface of the cover portion 18 and the buffer member 38 is disposed in the shaft holding portion 31 (on the upper surface of the bottom wall 33). According to such a configuration, with the shaft portion 41 being held in the shaft holding portion 31, noise is less likely to be caused while the vehicle 10 moves.

A battery is arranged in front of the luggage compartment 12 and the luggage front trim 16 includes the cover portion 18 that covers the battery so as to be accessible from the luggage compartment 12 side. The tow hook 40 is mounted on the front surface 18A of the cover portion 18.

### Other Embodiments

The technology described herein is not limited to the embodiments described above with reference to the drawings. The following embodiments may be included in the technical scope. The technology described herein may be modified within the technical scope.

(1) In the above embodiment, the tow hook 40 is described as an example of the bar member; however, the bar member may not be necessarily the tow hook 40. The hook portion 42 may not necessarily have a ring shape but may have a hook shape.

(2) In the above embodiment, the hook portion 42 and the hook holding portion 21 are configured as a stopper structure; however, a hook portion and a hook holding portion may not necessarily have a stopper structure. With the stopper structure being included, it may not be limited to the above embodiment but may be altered as appropriate.

(3) In the above embodiment, the hook holding portion 21 has a tubular shape that projects from the front surface 18A of the cover portion 18; however, the hook holding portion may have a solid columnar shape. In such a configuration, a stopper hole may be a recess recessed from an outer peripheral surface.

(4) In the above embodiment, with the tow hook 40 being mounted on the cover portion 18, the shaft portion 41 is horizontally disposed; however, the shaft portion may be vertically disposed or disposed with being tilted with respect to the horizontal direction.

(5) In the above embodiment, the shaft holding portion 31 has a groove shape; however, one or multiple hooks of a C-shape or a U-shape projecting from the cover portion 18 may be configured as the shaft holding portion.

(6) The shaft holding portion 31 may not include the stopper projections 36, the support ribs 37, and the buffer member 38.

(7) In the above embodiment, the tow hook holder 20 is on the front surface 18A of the cover portion 18 that is a portion of the front wall of the luggage compartment 12 of the vehicle 10; however, the tow hook holder may be on inner surface of the luggage compartment or may be mounted on a vehicular interior component of a train, an aircraft, and a ship.

1. A vehicular mount structure comprising:
a bar member including a shaft portion of a bar shape and a hook portion at one end of the shaft portion; and
a vehicular interior component of a plate shape having a plate surface, the vehicular interior component including
a hook holding portion configured to hold the hook portion, the hook holding portion projecting from the plate surface of the vehicular interior component, the hook portion being fitted to the hook holding portion so as to be rotatable around an outer peripheral surface of the hook holding portion in a circumferential direction, and
a shaft holding portion in which the shaft portion is arranged with extending along the plate surface of the vehicular interior component with the hook portion being fitted to the hook holding portion,
the shaft holding portion receiving the shaft portion of the bar member that is rotated around the hook holding portion fitted to the hook portion and is moved along the plate surface, the shaft portion being fitted in the shaft holding portion from a direction crossing an axial line of the shaft portion.

2. The vehicular mount structure according to claim 1, wherein the hook holding portion includes a hook stopper that holds the hook portion so as not to be detached with the shaft portion being held in the shaft holding portion.

3. The vehicular mount structure according to claim 1, wherein
the hook portion has a ring shape having an egg-shaped outline and includes a small diameter portion having a first radius of curvature and a large diameter portion having a second radius of curvature that is larger than the first radius of curvature of the small diameter portion,
the hook holding portion has an egg-shaped columnar shape so as to be fitted in the hook portion having the ring shape,
the hook holding portion includes a hook stopper portion in a peripheral wall of the hook holding portion, and
a portion of an inner peripheral portion of the hook portion that is rotated around the hook holding portion is fitted in the hook stopper portion of the hook holding portion.

4. The vehicular mount structure according to claim 1, wherein
the shaft holding portion has an opening that opens in a direction along the plate surface of the vehicular interior component, and
the shaft holding portion includes a stopper projection at an opening edge of the opening and the stopper projection is contacted with the shaft portion that is held in the shaft holding portion so as not to be out therefrom.

5. The vehicular mount structure according to claim 1, wherein
the shaft holding portion is a groove extending in an extending direction that is along the plate surface of the vehicular interior component, and
the shaft holding portion includes support ribs on an inner surface and the support ribs extend in a direction crossing the extending direction and support the shaft portion.

6. The vehicular mount structure according to claim 1, wherein
the shaft holding portion is a groove that extends along the plate surface of the vehicular interior component, and
a buffer member is in the shaft holding portion.

7. The vehicular mount structure according to claim 1, wherein the vehicular interior component is a luggage trim that is configured as a portion of a wall of a luggage compartment of a vehicle.

8. The vehicular mount structure according to claim 7, wherein
the luggage trim includes a cover portion that covers a functional component arranged in front of the luggage compartment such that the functional component is accessible from a luggage compartment side, and
the bar member is mounted on a luggage compartment exterior surface of the cover portion.

9. The vehicular mount structure according to claim 3, wherein
the hook stopper portion is a stopper hole in the peripheral wall of the hook holding portion, and
the portion of the inner peripheral portion of the hook portion is fitted in the stopper hole such that the hook portion is not rotated around the hook holding portion.

10. The vehicular mount structure according to claim 9, wherein
the hook holding portion includes a holder small diameter portion having a radius of curvature and a holder large diameter portion having a radius of curvature that is larger than the radius of curvature of the holder small diameter portion, and
the stopper hole is in the holder small diameter portion.

11. The vehicular mount structure according to claim 10, wherein
the hook holding portion projects vertically to the plate surface of the vehicular interior component,
the holder small diameter portion is upper than the holder large diameter portion with respect to an upper-bottom direction that is along the plate surface of the vehicular interior component, and
the stopper hole is in an upper portion of the holder small diameter portion.

12. The vehicular mount structure according to claim 1, wherein the hook portion of the tow hook is fitted to the hook holding portion in a direction crossing the plate surface of the vehicular interior component and the shaft portion of the tow hook is fitted in the shaft holding portion in a direction along the plate surface of the vehicular interior component.
